(19) United States
(12) Patent Application Publication
(10) Pub. No.: US 2008/0243437 A1
(43) Pub. Date: Oct. 2, 2008

(54) TECHNIQUE FOR DETECTING ANOMALY IN OBSERVATION TARGET

(75) Inventors: Tsuyoshi Ide, Kanagawa-ken (JP); Shoko Suzuki, Kanagawa-ken (JP)

Correspondence Address: SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 12/133,600

(22) Filed: Jun. 5, 2008

Related U.S. Application Data
(63) Continuation of application No. 11/951,461, filed on Dec. 6, 2007.

(30) Foreign Application Priority Data
Dec. 11, 2006 (JP) 2006-332773

(51) Int. Cl. G06F 15/00

(52) U.S. Cl. 702/183

(57) ABSTRACT

A system, method, and computer program product allowing an information processing apparatus to function as a system for detecting an anomaly in an observation target on the basis of time series data. The system includes a first generation unit, a second generation unit, a singular vector computation unit, a matrix product computation unit, an element computation unit, an eigenvector computation unit and a change degree computation unit. The change degree computation unit computes the degree of change in the observation target from the reference periods to the target periods for anomaly detection, on the basis of a linear combination of the inner products between each of the eigenvectors and a singular vector, and then outputs the computed degree as a score indicating an anomaly in the observation target.

### CROSS REFERENCE TO RELATED APPLICATIONS

This application claims the benefit of Japanese Patent Application No. 2006-332773 filed Dec. 11, 2006, the contents of which are hereby incorporated by reference.

### BACKGROUND OF THE INVENTION

The present invention relates to a technique for detecting anomalies in an observation target. In particular, the present invention relates to a technique for detecting anomalies in an observation target on the basis of time series data of observed values obtained from the observation target.

In recent years, various kinds of observed values can be obtained from various kinds of observation targets such as a operational status of factory equipment, running conditions of an automobile, or indices of economic activity. In some cases, an increase in complexity of an observation target makes it difficult to clearly recognize which level of an observed value indicates what kind of condition the observation target is in. For example, although there is a possible method with which an occurrence of an anomaly in an observation target is detected when an observed value exceeds a certain threshold, setting an appropriate value for the threshold is not easy. When a large number of observed values are obtained in parallel from one observation target, it is difficult to acquire sufficient background knowledge on characteristics of the respective observed values, which further complicates the setting of the threshold. In addition, it is even more difficult to recognize the status of an observation target in real time due to a restriction on a time required for analysis of observed values.

As an effective method in a case of not having background knowledge on characteristics of observed values, there has been proposed a method of detecting a change in the characteristics of the observed values. For example, a method using wavelet transformation is known as such a method. Even in this method, however, certain background knowledge must be needed for adjusting parameters. Instead of this, there is another employed method of detecting a change of a parameter in its distribution function on the assumption that observed values distribute as a multivariate normal distribution. However, in some cases, such assumption that observed values distribute as a multivariate normal distribution is inadequate.

In contrast to this, change point analysis using a singular spectrum transformation method makes it possible to appropriately detect a change in observed values without having background knowledge on the characteristics of the observed values (see T. Idé and K. Inoue, “Knowledge discovery from heterogeneous dynamic systems using change-point correlations,” In Proceedings of 2005 SIAM International Conference on Data Mining (SDM 05), pages 571-575, 2005). In this method, however, when the number of dimensions of a matrix to be analyzed using the singular spectrum analysis is large, the analysis may not be completed within a realistic computation period. Since the number of dimensions of such a matrix increases in proportion to the time length to be observed, it is difficult to apply this method to real-time analysis when the analysis aims to detect a change in an observation target with high accuracy by observing the observation target for a sufficiently long observation period.

### SUMMARY OF THE INVENTION

In one aspect of the present invention, a system for detecting an anomaly in an observation target on the basis of time series data of observed values obtained by observing the observation target, comprises a first generation unit for generating a first matrix by arranging, as a column vector, each of a plurality of time series data subsequences, out of the time series data, respectively observed in a plurality of reference periods for anomaly detection; a second generation unit for generating a second matrix by arranging, as a column vector, each of a plurality of time series data subsequences, out of the time series data, respectively observed in a plurality of target periods for anomaly detection; a singular vector computation unit for computing a singular vector of the second matrix; a matrix product computation unit for computing a product matrix by multiplying the first matrix by the transposed matrix of the first matrix from the right; an element computation unit for computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix; an eigenvector computation unit for computing eigenvectors of the tridiagonal matrix; and a change degree computation unit for computing the degree of change in the observation target from the reference periods to the target periods for anomaly detection, on the basis of a linear combination of the inner products between each of the eigenvectors and the singular vector, and for outputting the computed degree as a score indicating an anomaly in the observation target.

In another aspect of the present invention, a method for detecting an anomaly in an observation target on the basis of time series data of observed values obtained by observing the observation target, comprises generating a first matrix by arranging, as a column vector, each of a plurality of time series data subsequences, out of the time series data, respectively observed in a plurality of reference periods for anomaly detection; generating a second matrix by arranging a plurality of time series data subsequences, out of the time series data, respectively observed in a plurality of target periods for anomaly detection; computing a singular vector of the second matrix, computing a product matrix by multiplying the first matrix by the transposed matrix of the first matrix from the right; computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix, computing eigenvectors of the tridiagonal matrix, computing the degree of change in the observation target from the reference periods to the target periods for anomaly detection, on the basis of a linear combination of the inner products between each of the eigenvectors and the singular vector, and outputting the computed degree as a score indicating an anomaly in the observation target.

In still another aspect of the present invention, a computer program product comprising a computer useable medium including a computer readable program, wherein the computer readable program when executed on a computer causes the computer to function as a system for detecting an anomaly in an observation target on the basis of time series data of observed values obtained by observing the observation target, the computer program product causing the computer to function as a system for detecting an anomaly in an observation target on the basis of time series data of observed values obtained by observing the observation target, the computer program causing the computer to function as a first generation unit for generating a first matrix by arranging, as a column vector, each of a plurality of time series data subsequences, out of the time series data, respectively observed in a plurality of reference periods for anomaly detection; a second generation unit for generating a second matrix by arranging, as a column vector, each of a plurality of time series data subsequences, out of the time series data, respectively observed in a plurality of target periods for anomaly detection; a singular vector computation unit for computing a singular vector of the second matrix; a matrix product computation unit for computing a product matrix by multiplying the first matrix by the transposed matrix of the first matrix from the right; an element computation unit for computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix; an eigenvector computation unit for computing eigenvectors of the tridiagonal matrix; and a change degree computation unit for computing the degree of change in the observation target from the reference periods to the target periods for anomaly detection, on the basis of a linear combination of the inner products between each of the eigenvectors and the singular vector, and for outputting the computed degree as a score indicating an anomaly in the observation target.

These and other features, aspects and advantages of the present invention will become better understood with reference to the following drawings, description and claims.

### BRIEF DESCRIPTION OF THE DRAWINGS

FIG. 1 is a schematic diagram of a peripheral configuration of a detection system 30 according to the present invention;

FIGS. 2A to 2E are line charts with specific examples of time series data stored in a database device 20 according to the present invention;

FIG. 3 is a system diagram of the detection system 30 according to the present invention;

FIG. 4 is a line chart with an example of a first matrix and a second matrix generated from time series data according to the present invention;

FIG. 5 is a flow chart of processing in which the detection system 30 computes the degree of change by using time series data obtained with sequential observation according to the present invention;

FIG. 6 is a flow chart illustrating a specific example of processing in S540 according to the present invention;

FIG. 7 is a bar chart times required for computation of the degree of change according to the present invention;

FIG. 8 is a set of three line charts illustrating specific examples of computed degrees of change in comparison with time series data according to the present invention; and

FIG. 9 is a system plan showing the hardware configuration of an information processing apparatus 500 functioning as the detection system 30 according to the present invention.

### DETAILED DESCRIPTION OF THE PREFERRED EMBODIMENT

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates to a technique for detecting anomalies in an observation target on the basis of time series data using observed values obtained from the observation target. Anomaly detection is useful, among other applications, for determining the operational status of factory equipment or detecting the running conditions of an automobile. Anomaly detection is also useful in the fields of finance and economics where time series data is used for predictive, explanatory and financial engineering purposes.

In contrast to the prior art, the present invention eliminates the need to directly calculate the singular vectors of a first, dense matrix of time series data in order to detect an anomaly within the time series data and instead computes a score interpreted as a change in the trend of observed values and uses a carefully designed Krylov subspace to allow such anomaly detection, vastly reducing computational cost. The computational cost of dense matrix singular vectors can be prohibitive in the deployment of anomaly detection in a real-time setting.

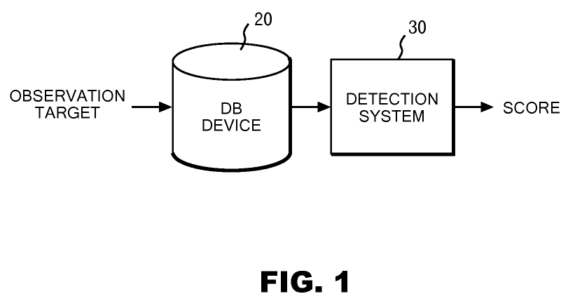

FIG. 1 schematically shows a peripheral configuration of a detection system 30. Time series data of observed values obtained by observing an observation target are stored in a database device 20. An example of the observation target is steelmaking equipment in a steelmaking plant, and an example of the observed values is the tension of steel strips sequentially manufactured with the steelmaking equipment. Another example of the observation target may be a running automobile. In this case, observed values may be not only continuous values such as a speed of the automobile and the number of revolutions of the engine, but also discrete values such as the shift position and an ON/OFF state of each of various functions. The database device 20 may store the observed values by obtaining them in real time. To be more precise, every time new observed values are obtained from the observation target, the database device 20 may add the new observed values to the end of the already-stored time series data.

The detection system 30 detects an anomaly in the observation target by using the time series data stored in the database device 20. For example, in the example of the steelmaking equipment, when any change in the transition of the tension of steel strips is detected, it is decided that a certain anomaly occurs in the steelmaking equipment, which is the observation target. In such a decision on an anomaly, if sufficient background knowledge on characteristics of the observation target is not obtained, it is difficult to detect the anomaly with high accuracy by use of a method of comparing the observed values with a predetermined threshold, or another equivalent method. In contrast to this, the detection system 30 according to the present invention aims to detect an anomaly occurring in an observation target with high accuracy by use of a high-speed computation method without having to obtain background knowledge on the observation target. Thereby, a real-time anomaly detection for a complicated observation target such as plant equipment or an automobile can be achieved without requiring highly-confidential information on its design information and the like.

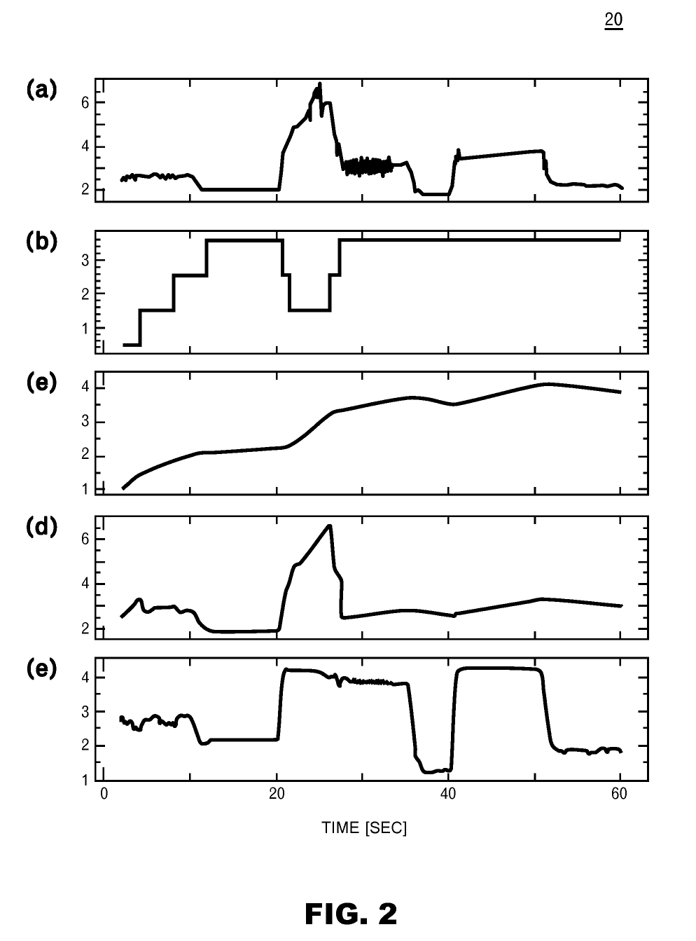

FIGS. 2A to 2E show specific examples of the time series data stored in the database device 20. The time series data shown in FIGS. 2A to 2E are time series data of observed values obtained by respectively observing some parts in an automobile, and generated by a certain automobile simulator. FIGS. 2A to 2E show the time series data of the observed values obtained by observing the respective parts different from one another. Each set of the time series data includes 580 observed values obtained by observing the part at intervals of 100 ms. The time series data may include physical values such as the number of revolutions or a speed, and a preset values such as the shift position. FIGS. 2A to 2E each show the observed values normalized so that the distribution thereof is 1, and that the mean thereof is 3 (no unit).

The database device 20 stores each set of such time series data so that the observed values included in the time series data are each associated with its observation time. In addition, the database device 20 outputs the observed values stored therein, to the detection system 30 in response to a readout instruction from the detection system 30.

Hereinafter, descriptions will be provided for a function of detecting an anomaly in the observation target by using one set of a large number of time series data sets thus obtained.

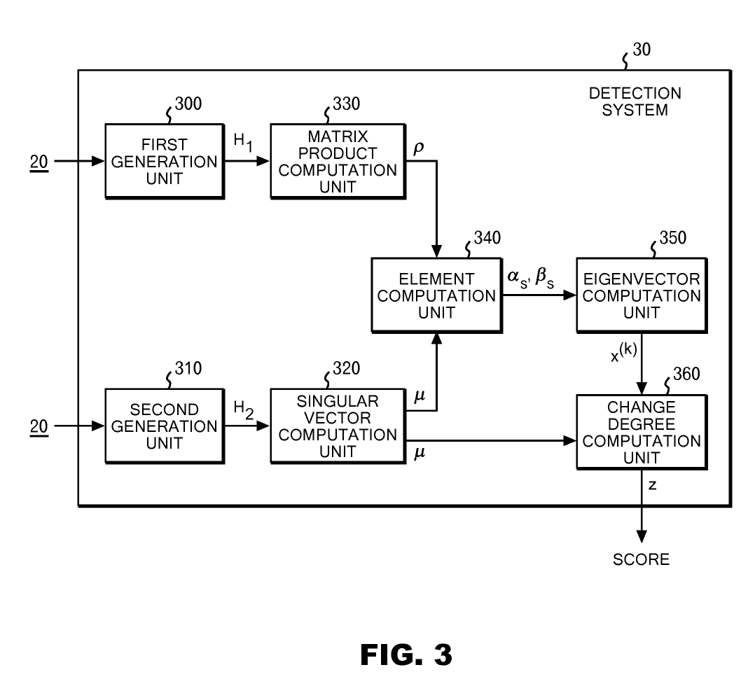

FIG. 3 shows a functional configuration of the detection system 30. The detection system 30 includes a first generation unit 300, a second generation unit 310, a singular vector computation unit 320, a matrix product computation unit 330, an element computation unit 340, an eigenvector computation unit 350 and a change degree computation unit 360. Firstly, the relationships between all the units and hardware resources will be described. The detection system 30 is implemented by using a later-described information processing apparatus 500. A program read into the information processing apparatus 500 causes a CPU 1000 and a RAM 1020, which will be described later, to work together, thereby allowing the information processing apparatus 500 to function as the first generation unit 300, the second generation unit 310, the singular vector computation unit 320, the matrix product computation unit 330, the element computation unit 340, the eigenvector computation unit 350 and the change degree computation unit 360.

The first generation unit 300 uses a certain time point as a reference time point, searches out observed values corresponding to the respective time points after the reference time point, from the database device 20, and then reads the searched-out observed values as time series data from the database device 20. The first generation unit 300 generates a first matrix by arranging, as column vectors, a plurality of time series data subsequences in the time series data. Here, a time series data subsequence includes observed values obtained within each of a plurality of reference periods for anomaly detection. The generated first matrix is outputted to the matrix product computation unit 330. This matrix is called a matrix H₁.

The first generation unit 300 may store, in the RAM 1020, the entire first matrix thus generated, and then may read and output the matrix to the matrix product computation unit 330 in response to a request from the matrix product computation unit 330. Instead of this, the first generation unit 300 may receive a request designating a line number and a column number, generate the element designated by the line number and the column number, in the first matrix, and output only the element to the matrix product computation unit 330. In this case, the first generation unit 300 does not have to store the entire first matrix in the RAM 1020, and thereby the necessary capacity of the RAM 1020 can be reduced.

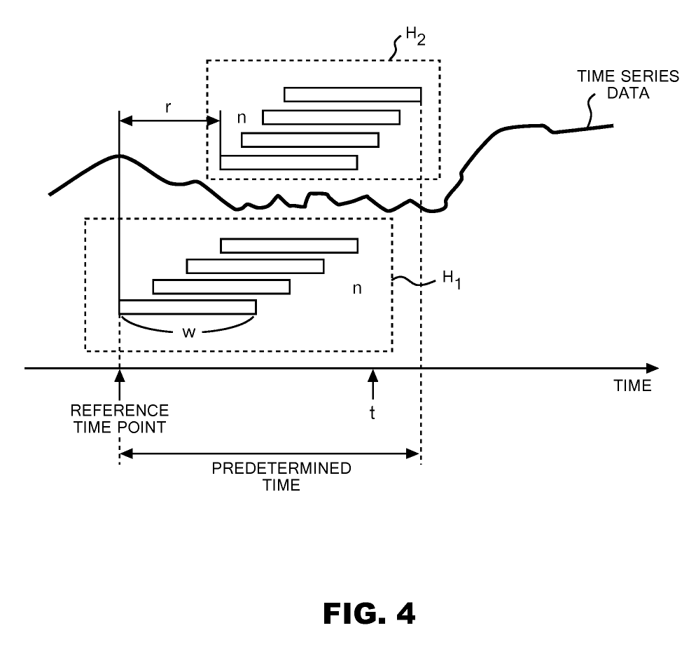

The second generation unit 310 reads the time series data from the database device 20 in a similar manner to that of the first generation unit 300. Then, the second generation unit 310 generates a second matrix in which a plurality of time series data subsequences are arranged as column vectors. Here, a time series data subsequence includes observed values obtained within each of a plurality of target periods for anomaly detection. The generated second matrix is outputted to the singular vector computation unit 320. This second matrix is called a matrix H₂. The first matrix and the second matrix will be described below by comparing them with each other with reference to FIG. 4.

FIG. 4 shows one example of the first matrix and the second matrix generated from time series data. A line graph in FIG. 4 indicates the time series data. Each of rectangular areas in FIG. 4 schematically shows a period for generating a time series data subsequence. To be more precise, each of the rectangular areas corresponds to a period when observed values constituting each time series data subsequence are observed. The first matrix (H₁) is the one in which the time series data subsequences of the respective reference periods for anomaly detection are arranged, and is preferably generated on the basis of a history of observed values obtained by observing an observation target. The reference periods have the same time length w, and start at the respective time points obtained by accumulatively and sequentially adding a predetermined difference period to a certain first reference time point. The number of reference periods is n. For example, when observed values in time series data are 1, 2, 3, 4, 5, . . . , k, . . . , and when w=3, the time series data subsequences are (1, 2, 3), (2, 3, 4), . . . , (k, k+1, k+2), and so on.

Moreover, the reference time point is a time point that precedes, for a predetermined period, a time when a new observed value is obtained in real time, and that is set every time a new observed value is obtained. In addition, here, the unit of the length w is the number of observed values that are periodically obtained. In this case, the predetermined difference period is equivalent to one of intervals at which the observed values are obtained. Instead of this, the length w may be predefined as one indicating the time length of an observation period, and the difference period may also be predefined as a time length. Similarly, the second matrix (H₂) is the one in which the time series data subsequences of the respective target periods for anomaly detection are arranged. The target periods have the same time length w, and start at the respective time points obtained by accumulatively and sequentially adding the predetermined difference period to a second reference time point following the first reference time point after a predetermined period (γ). The number of target periods is also n.

The detection system 30 according to this embodiment compares a part of the time series data expressed as the second matrix H₂ with a part of the time series data expressed as the first matrix H₁. Thereby, the detection system 30 detects an occurrence of an anomaly in the observation target around a time when a new observed value is obtained, that is, for example, at a certain time point t that is a little bit before the current time. It is known that the reliability of anomaly detection can be increased by setting an observation period to have a certain width w, and by extracting a plurality of subsequences of observation periods shifted little by little, by use of the sliding window technique as described above. Moreover, it is also known that a comparison between singular vectors of the first and second matrices H₁ and H₂ is effective for comparing the first and second matrices H₁ and H₂ in each of which the subsequences thus extracted are arranged as column vectors. This idea is called singular spectrum transformation (SST) (see the foregoing T. Idé and K. Inoue, “Knowledge discovery from heterogeneous dynamic systems using change-point correlations,” In Proceedings of 2005 SIAM International Conference on Data Mining (SDM 05), pages 571-575, 2005).

For example, if it is possible to calculate k left-singular vectors of the first matrix H₁ corresponding to the largest k singular values, and then to find the angle between the hyperplane spanned by the left singular vectors, and a left singular vector of the second matrix H₂, the angle could be used as a score indicating the degree of change in the observed values. In some cases, however, it may take a long time for computing the left singular vectors, and thereby the calculation may not be completed within a realistic time period. For example, if Householder's method, which is a standard method for singular value decomposition (SVD), is simply used to obtain the singular vectors, the computational cost for large matrices would be quite expensive, so that the computation at each time would not be completed until the next time comes. Although the computational cost is reduced if a small w is chosen (resulting in a small size of matrix), placing such a constraint is undesirable in practice, since w should be determined considering the scale of changes of the data. In addition, efficient SVD algorithms which have been widely used for sparse systems (see G. H. Golub and C. F. V. Loan. Matrix computations (3rd ed.). Johns Hopkins University Press, Baltimore, Md., 1996) are not applicable in this case, since the aforementioned first matrix H₁ is not sparse but dense. On the other hand, general-purpose iterative algorithms such as the orthogonal iteration method (see G. H. Golub and C. F. V. Loan. Matrix computations (3rd ed.). Johns Hopkins University Press, Baltimore, Md., 1996) are not fast enough, if they are simply used to perform the SVD.

In contrast to them, the detection system 30 according to this embodiment computes a score interpreted as a change in the trend of observed values, by using the notion of the Krylov subspace, which is carefully designed so that the dimension of the subspace is kept sufficiently smaller than that of the original column space of H₁ while sufficiently reflecting characteristics of observed values appearing in H₁. This makes it unnecessary to directly calculate the singular vectors of the first matrix H₁, resulting in dramatic savings of the time required for the singular vectors. The specific 20 description will be provided below.

Incidentally, as a precondition for the following description, assume that a singular vector or an eigenvector is normalized so that the L₂ norm thereof is 1. In addition, assume that the window width w is an input parameter, and set n=w and γ=n/2 for n and γ, respectively (other values may be set therefor since the detection result is not sensitive to the choices of n and γ).

The description goes back to FIG. 3. The singular vector computation unit 320 computes one of the left singular vectors of the second matrix H₂ corresponding to the largest singular value. The left singular vector thus computed is called μ. The matrix product computation unit 330 computes a product matrix by multiplying the first matrix H₁ by the transposed matrix of the first matrix H₁ from the right. This product matrix is called ρ, that is, ρ=H₁H₁^{T}. Since the eigenvector of the product matrix ρ is equal to the singular vector of the original first matrix H₁ (see Gilbert Strang, “Linear Algebra and Its Applications,” Academic Press, 1976), descriptions will be provided hereinafter for a course for finding this eigenvector in an approximate manner. Next, the element computation unit 340 computes the diagonal elements αₛ and subdiagonal elements βₛ of the tridiagonal matrix T. Theoretically, this matrix T can be shown to be identical to a matrix obtained by tridiagonalizing using a matrix Q as Q^{T}ρQ, where Q^{T} denotes the transposed matrix of the matrix Q. Here, the matrix Q is defined as one whose column vectors qᵢ are orthonormal bases of the Krylov subspace induced by the product matrix ρ and the seed vector μ. If the dimension of the Krylov subspace is denoted by r, this computation unit 340 is to compute the diagonal elements α₀, . . . , αᵣ₋₁, and the subdiagonal elements β₀, . . . , βᵣ₋₁

The eigenvector computation unit 350 computes eigenvectors x⁽ⁱ⁾ of this tridiagonal matrix T. Preferably, the eigenvector computation unit 350 computes k eigenvectors x⁽¹⁾ to x^{(k)} associated with the largest k eigenvalues, where the number k is less than the number r of dimensions of the Krylov subspace. Then, on the basis of a linear combination of the inner products between each of the eigenvectors and the singular vector μ, the change degree computation unit 360 computes a score z indicating the degree of change in the observation target from a reference period to a target period for anomaly detection. This score thus computed indicates the angle between the hyperplane spanned by the singular vectors of the first matrix H₁, and the singular vector μ of the second matrix H₂. Then, the change degree computation unit 360 outputs the computed score z as a score indicating whether or not an anomaly occurs in the observation target. For example, a score indicating a change in the tension of steel strips is used as this score in the case of steelmaking equipment. By using this score, anomalies in the steelmaking equipment can be detected.

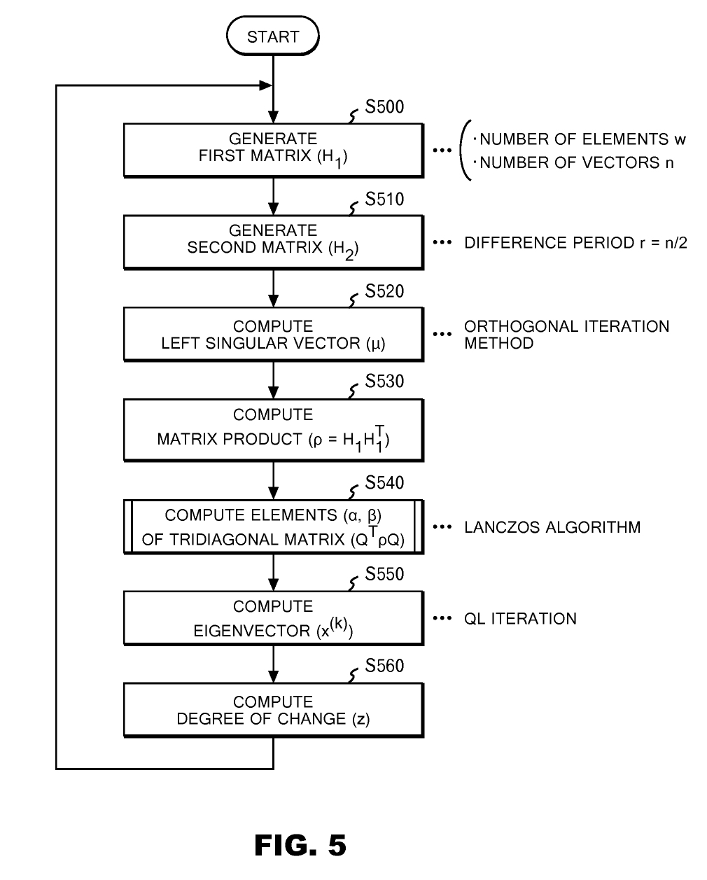

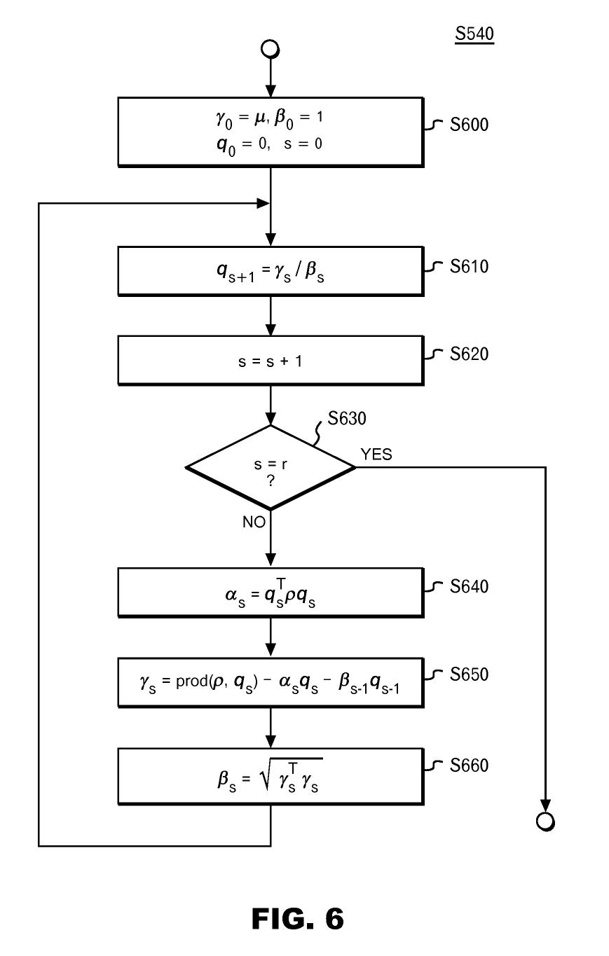

Subsequently, processing for computing a change degree will be further described in detail by referring to FIGS. 5 and 6. Prior to this description, here, the definition of a score z to be computed will be explained. The score z indicates the degree of change in observed values. The degree of change indicates the difference between the first matrix H₁ and the second matrix H₂, and is intuitively understood as the angle between the hyperplane spanned by the singular vectors of the first matrix H₁, and the singular vector of the second matrix H₂. Here, as the score z, introduced is a score that can be expressed by using the linear combination of the inner products between vectors while having a feature similar to the above angle. To be more precise, the score indicates an amount interpretable as the square of the distance between a space formed by the singular vectors of the first matrix H₁ and a space formed by the singular vectors of the second matrix H₂, and is defined as the following equation (1). Incidentally, refer to G. H. Golub and C. F. V. Loan. Matrix computations (3rd ed.). Johns Hopkins University Press, Baltimore, Md., 1996 in regard to the concept of the distance between spaces.

$$z = 1 - {\sum }_{i = 1}^{k} {K ( i , μ )}^{2} \qquad equation ( 1 )$$

Here, K denotes an inner product or an amount based on the inner product, and is expressed as the following equation (2).

K(i, μ)≡μ^{T}u⁽ⁱ⁾ equation (2)

where u^{(l)} to u^{(k)} denote the singular vectors of the first matrix H₁. One straightforward approach to computing the score is to find the singular vectors explicitly in advance for computing the inner product. As mentioned before, however, such an approach is computationally prohibitive in practice. Hereinafter, we show that, based on an approximation explained later, K can be found without explicitly calculating the singular vectors, while keeping the accuracy sufficiently high.

FIG. 5 shows a flowchart of processing in which the detection system 30 computes the degree of change on the basis of time series data that are sequentially observed. The detection system 30 executes the following processing every time a new observed value is obtained, or at constant intervals in a situation where observed values are sequentially obtained. Firstly, the first generation unit 300 generates a first matrix H₁ for a plurality of periods based on a first reference time point that precedes the current time point for a predetermined period (S500). In this first matrix H₁, n time series data subsequences each containing w observed values as w elements are arranged as column vectors. The first generation unit 300 executes this processing successively in response to the event of obtaining observed values, and thereby generates the subsequent first matrices one by one for a plurality of periods each starting at a time point later than one of the periods that have been used for generating the preceding first matrices.

Next, the second generation unit 310 generates a second matrix H₂ (S510). This second matrix H₂ is generated by using a second reference time point for starting the observation that is later by γ than the first reference time point of the first matrix H₁. In this embodiment, γ is set to be γ=n/2, as described above. The second generation unit 310 executes the foregoing processing every time a new observed value is obtained from the observation target, and thereby generates the subsequent second matrices one by one for a plurality of periods each starting at a time point later than one of the periods that have been used for generating the preceding second matrices.

Then, the singular vector computation unit 320 computes the left singular vector of the second matrix H₂ corresponding to the largest singular value (S520). This computing processing is implemented by using the orthogonal iteration method (see G. H. Golub and C. F. V. Loan. Matrix computations (3rd ed.). Johns Hopkins University Press, Baltimore, Md., 1996), for example. The orthogonal iteration method allows an approximate solution to the left singular vector to be computed with high accuracy by gradually approximating the initial value of a given solution to the correct solution with iterative processing. Accordingly, obtaining a more approximate initial value of a solution makes the time required for the computation shorter, and also makes it easier to obtain the high computation accuracy. For this reason, preferably, the singular vector computation unit 320 computes, as the initial value of a solution, the left singular vector of the next second matrix with an orthogonal iteration method using a vector based on the singular vector computed for the previous second matrix. This is because the singular vectors of the previous and next second matrices must be similar to each other, since major parts of observed values included in the previous and next second matrices are common. More preferably, the singular vector computation unit 320 may also compute the singular vector of the next second matrix with an orthogonal iteration method using, as the initial value of a solution, a vector obtained by adding another vector to the singular vector computed for the previous second matrix. Specifically, the added vector has a different direction from that of the singular vector, and is shorter than the singular vector. With this vector addition, a component not included in the previous singular vector would be slightly included in the initial value of a solution. Consequently, even when the singular vector to be currently computed includes a component not included in the previous singular vector, the solution with high accuracy can be found quickly.

Next, the matrix product computation unit 330 computes a product matrix ρ (S530). The left singular vector μ can be found as the solution of a variational equation shown as the following equation (3). Prior to the description of the next step S540, descriptions will be provided for a fact that, even if the number r of dimensions of the Krylov subspace of the matrix ρ is considerably smaller than the number w of lines of the product matrix ρ, the subspace strongly reflects a feature of the singular vector of the matrix ρ.

$$u = arg {max}_{u} R ( u ) , \\ where \\ R ( u ) = \frac{{u}^{T} ρ u}{{u}^{T} u} \qquad equation ( 3 )$$

R(u) is a quantity called the Rayleigh quotient (see Gilbert Strang, “Linear Algebra and Its Applications,” Academic Press, 1976 for more details). Here, consider the following problem. “Given an s-dimensional subspace Vₛ (s is smaller than w), construct a (s+1)-dimensional subspace Vₛ₊₁ by adding a vector so that the increase of the overlap between Vₛ₊₁ and the highest eigenvectors is maximized.” As the first step, consider the solution of this problem when s=1. At this moment, assume a base μ obtained by normalizing a certain L2 norm. In order to satisfy the requirement, when a two-dimensional space such as span {μ, Δ} is constructed by adding another base to span {μ}, the added base should contain the steepest ascent direction of R. Note that span {x, y, z, . . . } denotes a space spanned by vectors x, y, z, . . . . The gradient of R is expressed as the following equation (4).

$$\frac{d}{d u} R ( u ) {\vert}_{u = μ} = \frac{- 2}{{μ}^{T} μ} [ R ( μ ) μ - ρ μ ] \qquad equation ( 4 )$$

This equation suggests that what should be added to span {μ} is ρμ, since span {μ, ρμ} includes the above steepest ascent direction. Now we have Δ=ρμ. This is also true for higher dimensions. By continuing the similar discussion, it is understood that an r-dimensional space expressed as the following equation (5) is the best r-dimensional subspace in terms of maximization of R.

Kᵣ(μ, ρ)≡span {μ, ρμ, . . . , ρ^{r-1}μ} equation (5)

In other words, there are many choices of an r-dimensional subspace over the entire column space (with w-dimensions) of the first matrix H₁, but, among all of the choices, Kᵣ (μ, ρ) is the subspace that includes the maximum eigenstate most ‘densely’ under the constraint that μ is one of the bases. This is true for not only the maximum eigenstate, but also the second and third maximum eigenstates. In mathematics, this subspace is called the Krylov subspace (induced by μ and ρ).

Next, the element computation unit 340 computes the diagonal elements and subdiagonal elements of the matrix obtained by tridiagonalizing the product matrix ρ (S540). Theoretically, this matrix T can be shown to be identical to a matrix obtained by tridiagonalizing using a matrix Q as Q^{T}ρQ, where Q^{T} denotes the transposed matrix of the matrix Q. Here, the matrix Q is defined as one whose column vectors qₛ are orthonormal bases of the Krylov subspace induced by the product matrix ρ and the seed vector μ. If the dimension of the Krylov subspace is denoted by r (<w), there are r orthonormal bases thereof. Thus, the matrix Q is a w by r non-square matrix, and is expressed as the following congruence expression (6).

Q≡[q₁, . . . , qᵣ] equation (6)

Although the matrix Q is not unique in general, the QR factorization of the Krylov matrix [μ, ρμ, . . . , ρ^{r-1} μ] gives a solution of the column vectors qᵢ that satisfies the requirement that the top left singular vector μ of the second matrix H₂ must be the first orthogonal base. Since the QR factorization is essentially unique when the first base is specified, the Q matrix is also essentially unique under the requirement about μ. Now the eiqenequation is approximately reduced to the following equation (7) by using x=Q^{T}u that is a projection of u to the Krylov subspace Kᵣ(μ, ρ). One can intuitively understand this result by thinking about the extreme case of r=w. In this limit, the matrix Q becomes a square matrix, and the equation (7) is just a standard result of orthogonal transformation of the system.

Q^{T} ρQx=λx equation (7)

It is known that the coefficient matrix Q^{T}ρQ of the left side of this equation is a tridiagonal matrix owing to mathematical properties of QR factorization (the following equation (8), see G. H. Golub and C. F. V. Loan. Matrix computations (3rd ed.). Johns Hopkins University Press, Baltimore, Md, 1996). Since the matrix Q is a rectangular matrix that is vertically long, the number of lines of the matrix Q is smaller than that of the product matrix ρ.

T≡Q^{T} ρQ=(Tridiagonal Matrix) equation (8)

In theory, the product matrix ρ is tridiagonalized by multiplying the product matrix ρ by the square matrix Q from the right, and by the transposed matrix Q^{T} of the square matrix Q from the left, where the square matrix Q is one containing each of the orthonormal bases of the product matrix as a column vector. In practice, as described below, it is not necessary to explicitly calculate the matrix Q, and also to calculate the product of Q and ρ. (Note that, in reality, the matrix Q is a non-square matrix. For this reason, the matrix T is approximately tridiagonalized by approximately applying the above induction procedure to the non-square matrix Q, that is, by multiplying the matrix ρ by the non-square matrix Q from the right in place of the square matrix, and by the non-square transposed matrix Q^{T} from the left, in place of the square transposed matrix. However, this description is only for defining what the matrix T is, and the element computation unit 340 does not compute the product of Q and ρ, in reality.) Computing the diagonal elements and subdiagonal elements tridiagonalized by using the matrix Q can be implemented by passing the product matrix ρ, μ that is one of the orthonormal bases, and the number r of lines of the tridiagonal matrix to the Lanczos algorithm (see G. H. Golub and C. F. V. Loan. Matrix computations (3rd ed.). Johns Hopkins University Press, Baltimore, Md., 1996 for the Lanczos algorithm).

Subsequently, the eigenvector computation unit 350 computes the eigenvectors x⁽ⁱ⁾ of this tridiagonal matrix T whose diagonal elements and subdiagonal elements have been computed (S550). Preferably, the eigenvector computation unit 350 computes the k eigenvectors x^{(l)} to x^{(k)}, where k is smaller than the number r of dimensions of the Krylov subspace. It is known that the eigenvectors of a tridiagonal matrix can be calculated extremely efficiently. For example, the QR iteration algorithm preserves the tridiagonal structure throughout the entire iteration process. (that is, without generating an unnecessary non-zero component). In this way, the QR iteration algorithm works very efficiently for tridiagonal matrices. See H. Press, B. P. Flannery, S. A. Teukolsky, and W. T. Vetterling. Numerical Recipes. Cambridge University Press, 1989 in regard to specific computation processing, since it describes the processing as the tqli routine. In addition, the tridiagonal matrix T has the r by r structure that can be much smaller than the w by w structure of the product matrix ρ, and also has the tridiagonal structure that is particularly advantageous for the eigenvalue decomposition. As a result, the eigenvectors of the tridiagonal matrix T can be computed at an extremely high speed.

Next, the change degree computation unit 360 computes the degree of change in the observation target from a reference period to a target period for anomaly detection by using each of the computed eigenvectors x⁽ⁱ⁾ and the singular vector μ (S560). Here, detail descriptions for this will be provided. According to the foregoing descriptions, the eigenvectors {x^{(l)}, . . . , x^{(k)}} are not singular vectors in an original space spanned by the bases of the first matrix H₁, but are singular vectors in the Krylov subspace of the first matrix H₁. For this reason, one may consider that the singular vectors of the Krylov subspace need to be transformed to the singular vectors of the original space, in order to compute the score shown as the foregoing equation (1) on the basis of the singular vectors of the original space. This transformation is expressed as the following equation (9), where {μ^{(l)} , . . . , μ^{(k)}} denote the singular vectors obtained by the transformation.

$$\begin{matrix}{u}^{( α )} = {\sum }_{i = 1}^{k} {q}_{i} {x}_{i}^{( α )} & equation ( 9 ) \\ {u}^{( α )} = {\sum }_{i = 1}^{k} {q}_{i} {x}_{i}^{( α )} & equation ( 9 )\end{matrix}$$

where xᵢ^{(α)} denotes the i-th element of an r-dimensional vector x^{(α)}. The value of K based on the inner product in the foregoing equation (1) is given by the following equation (10) on the basis of {u^{(l)} , . . . , u^{(k)}} thus computed.

$$K ( α , μ ) = {\sum }_{i = 1}^{k} ( {μ}^{T} {q}_{i} ) {x}_{i}^{( α )} \qquad equation ( 10 )$$

In order to compute a score indicating the degree of change in the observation target by using the eigenvectors x⁽ⁱ⁾, explicit computation of qᵢs is unnecessary. This is because one of the orthonormal bases of the Krylov subspace has been set as the left singular vector u of the second matrix H₂. With this setting, the bases satisfies the relation of qᵢ^{T}qⱼ=δᵢⱼ(δ_{i,j} is the Kronecker delta, δ_{i,j} takes 1 when i=j, and δ_{i,j} takes 0 when i≠j), and the equation (10) is reduced to the following equation (11), where q₁=μ.

K(α, μ)=x₁^{(α)} equation (11)

As such, qᵢ does not appear in the right side of the equation (11). Moreover, when the foregoing equation (1) is transformed by using the equation (11), the following equation (12) is obtained, and this equation (12) also does not contain qᵢ.

$$z = 1 - {\sum }_{i = 1}^{k} {[ {x}_{1}^{( i )} ]}^{2} \qquad equation ( 12 )$$

Accordingly, the change degree computation unit 360 is capable of computing a score z indicating the degree of change only by passing each of the eigenvectors {x^{(l)}, . . . x^{(k)}} to the equation (12) without having to execute any additional transformation processing. Although the bases qᵢ and the product matrix ρ are needed if the transformation has to be performed, they are not needed in this case.

FIG. 6 shows a specific example of the processing in S540. By using, as inputs, the product matrix ρ, the number r of dimensions of the Krylov subspace, and μ that is one of the orthonormal bases of the Krylov subspace, this processing aims to figure out the diagonal elements αₛ and subdiagonal elements βₛ (0≦s≦r−1) of the matrix T obtained by tridiagonalizing the product matrix ρ. Incidentally, temporary variables s, γ₀ to γᵣ₋₁, and q₀ to qᵣ₋₁ are used in the course of the computation.

Firstly, the element computation unit 340 initializes γ₀, β₀, q₀ and s to μ, 1, 0 and 0, respectively (S600). To be more precise, for example, the element computation unit 340 reserves an area for storing the value of the variable γ₀ in a memory, and stores the value of the vector μ in the area. In the subsequent processing, the variable γ is referred only with the variable s as a suffix, and any other variable is not attached as a suffix to the variable γ. Accordingly, the element computation unit 340 uses this reserved area as a common area for storing the values of the respective variables γ₀ to γᵣ₋₁. Moreover, the element computation unit 340 reserves an area for storing the value of the variable β₀ in the memory, and stores a constant 1 in the area. Since a variable β is outputted as a final result with each of the values 1 to r−1 as a suffix, the element computation unit 340 reserves areas for respectively storing the values of the variable β₁ to βᵣ₋₁.

In addition, the element computation unit 340 reserves an area for storing the value of the variable q₀, and stores a constant 0 in the area. A variable q is referred with each of s+1, s and s−1 as a suffix. Note that the value assigned to the variable qₛ₊₁ in S610 is referred as the variable qₛ only in the processing after the variable s is incremented in S620. For this reason, a variable q is practically referred only with s or s−1 as the suffix. Accordingly, the element computation unit 340 does not have to reserve areas for storing the respective variables q₀ to qᵣ₋₁, but reserves only two areas for storing the respective variables qₛ and qₛ₋₁ in the memory. In S600, for example, the element computation unit 340 firstly reserves two areas for storing these two areas, and then stores a constant 0 in the area for storing the value of variable qₛ. In addition, the element computation unit 340 reserves an area for storing the value of the variable s in the memory, and stores a constant 0 in the area.

Subsequently, the element computation unit 340 generates a vector by dividing each element of the vector variable γₛ by βₛ, and sets the generated vector to be a vector qₛ₊₁ (S610). Specifically, for example, the element computation unit 340 reads the values of the variables γₛ s and βₛ from the memory, generates the vector qₛ₊₁ through arithmetic processing executed by the CPU 1000, and then stores the vector qₛ₊₁ the in the area reserved for storing the variable qₛ. Thereafter, the element computation unit 340 increments the variable s (S620). Along with this, the element computation unit 340 updates the vector value of the variable qₛ₋₁ with the vector value of the variable qₛ. Then, the element computation unit 340 judges whether or not the variable s is equal to the number r of dimensions (S630). If it is equal (S630: YES), the element computation unit 340 terminates the processing shown in FIG. 6.

If it is not equal (S630: NO), the element computation unit 340 multiplies the transposed vector qₛ^{T} by the product matrix ρ from the right, and multiplies the resultant transposed vector qₛ^{T} by the vector qₛ from the right. Then, the element computation unit 340 sets the resultant vector as αₛ (S640). At this time, if an area for storing each of the values α₁ to αᵣ₋₁ is not yet reserved in the memory, the element computation unit 340 reserves these areas firstly, and then stores the computation result in the area corresponding to the value s, which is currently handled.

Next, the element computation unit 340 executes an operation of subtracting two vectors from a vector obtained by multiplying the product matrix ρ by the vector qₛ from the right. One of the two vectors is obtained by multiplying each element of the vector qₛ by αₛ, and the other vector is obtained by multiplying each element of the vector qₛ₋₁ by βₛ₋₁. Then, the element computation unit 340 sets the resultant vector as the vector γₛ (S650). More precisely, the vector qₛ is obtained by reading the vector value from the area reserved for storing the vector qₛ. The vector qₛ₋₁ is obtained by reading the vector value from the area reserved for storing the vector qₛ₋₁. In addition, αₛ and β₁₋₁ are obtained in the same manner. The computed γₛ is stored in the area for storing γₛ by overwriting the previously-computed value of γₛ. Then, the element computation unit 340 finds the product of the computed vector γₛ and the transposed matrix of the vector γₛ, computes the square root thereof, and sets the result as βₛ (S660). The element computation unit 340 goes back to S610, and repeats the processing.

As described above by referring to FIG. 6, the element computation unit 340 achieves the computation of the diagonal elements and subdiagonal elements by repeating the processing the number of times in proportional to the number r of dimensions. In this way, a solution with high accuracy can be computed within a stable time in comparison with the method for converging and determining a solution by gradually improving the accuracy of an approximate solution through the iteration method. Moreover, since the variables γ and q are referred only with s or s−1 as the suffix in the course of the repetitive processing, the memory capacity required for storing the values of the variables can be reduced up to an extremely small capacity.

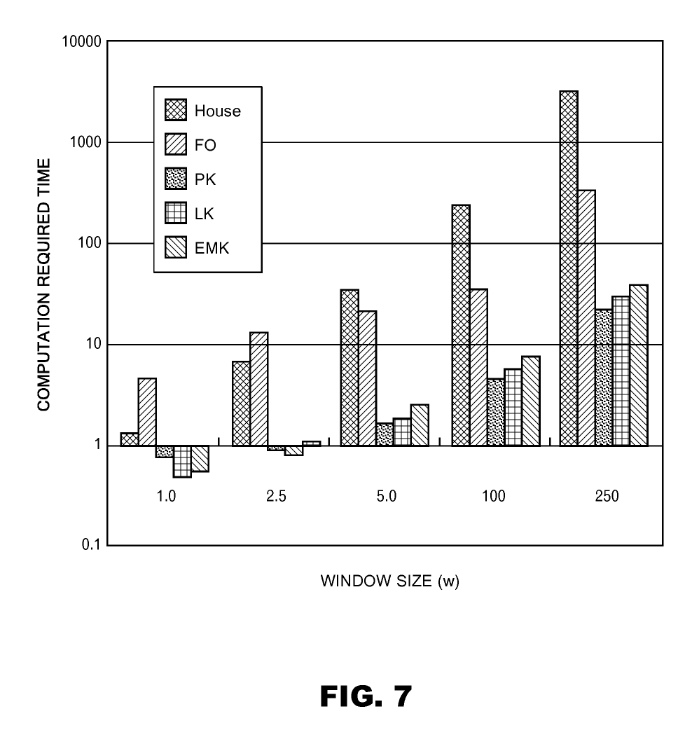

FIG. 7 shows times required for computing the degree of change. The performance of the detection system 30 according to this embodiment will be described by referring to FIG. 7. The degree of change in time series data generated with the automobile simulator described above was computed by using each of the five different methods, and the required computation time was measured. A symbol “House” denotes a computation time required for a method of directly computing the singular values of the first matrix H₁ by using a combination of the Householder method (see H. Press, B. P. Flannery, S. A. Teukolsky, and W. T. Vetterling. Numerical Recipes. Cambridge University Press, 1989) and the QR iteration method. Note that required times are each indicated as a value on a logarithm scale, obtained by normalizing its required time with a certain value set as 1.

In addition, a symbol “FO” denotes a computation time required for a method that employs the orthogonal iteration method for a part of the “House” method to which the Household method is applied. As the values of the length w of the observation time period become larger, the times required for this method become shorter than the times required for the “House” method. Note that computation times required for other methods each for finding a solution with a certain level of accuracy for a dense matrix are approximately equal to the times required for these two methods, as is known (see M. Brand. Fast online SVD revisions for lightweight recommender systems. In Proc. SIAM International Conference on Data Mining, 2003, for example). In addition, a symbol “PK” denotes computation times required by the detection system 30 according to this embodiment. Further, a symbol “LK” denotes computation time required for a method of directly finding the singular vectors from the first matrix H₁ by using a method in which the Lanczos algorithm known as an excellent approximation method for sparse matrix computation is combined with the QL iteration method (see William H. Press, Brian P. Flannery, Saul A. Teukolsky, and William T. Vetterling, “Numerical Recipes in C: The Art of Scientific Computing,” 2nd ed., Cambridge University Press, 1992, Section 11.3), for the purpose of making a comparison with this embodiment. Additionally, a symbol “EMK” denotes computation times required for a method of directly finding the singular vectors from the first matrix H₁ by using the EM-PCA method (see S. Roweis. EM algorithms for PCA and SPCA. In M. I. Jordan, M. J. Kearns, and S. A. Solla, editors, Advances in Neural Information Processing Systems, volume 10. The MIT Press, 1998) also known as a sparse matrix computation method. However, these two methods fail to achieve computation with sufficient accuracy even when being applied to a dense matrix such as the matrix H₁ employed in this embodiment. In contrast to them, the detection system 30 according to this embodiment can speed up the computation up to a level that have not been achieved by using any method based on the idea of directly finding the singular vectors of the first matrix H₁.

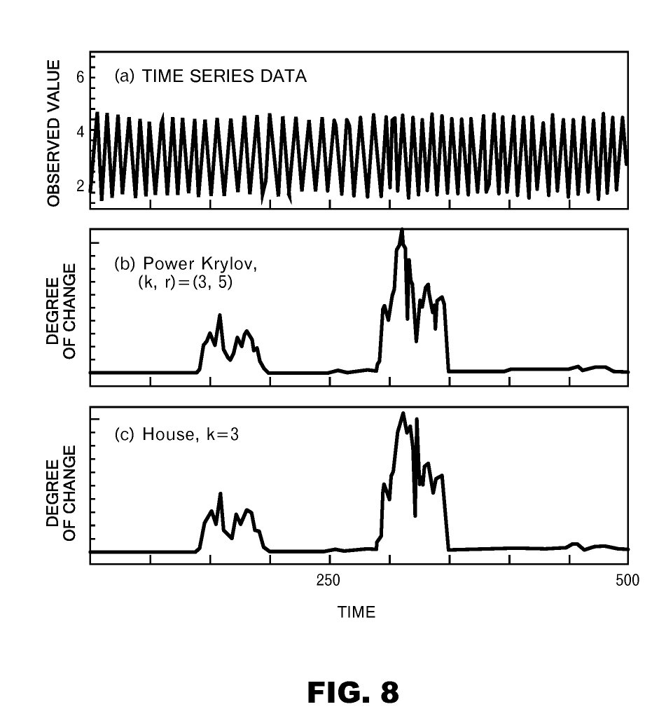

FIGS. 8A to 8C show specific examples of the computed degrees of change in comparison with time series data. FIG. 8A shows the time series data of observed values. The time series data were provided with artificial noise in addition to the periodical change of the observed values. FIG. 8B shows a computation result of the degree of change that was obtained by use of the detection system 30 according to this embodiment. Moreover, FIG. 8C shows a computation result of the degree of change that was obtained by use of the method explained as the above “House” method. Here, the values of the foregoing variables k and r were set at 3 and 5, respectively. (Incidentally, as described in T. Idé, “Why does subsequence time-series clustering produce sine waves?,” In Proceedings of the 10th European Conference on Principles and Practice of Knowledge Discovery in Databases (PKDD), Sep. 18-22, 2006; Lecture Notes in Artificial Intelligence 4213, Springer, pp. 311-322, a small integer on the order of 3 is known to be enough for the value of the variable k indicating the number of eigenvectors, regardless of the number w of observed values in an entire observation period.) As compared 8B with 8C, there is substantially no difference therebetween. Consequently, it was confirmed that the accuracy in computation of the degree of change is sufficiently high by using the detection system 30 according to this embodiment.

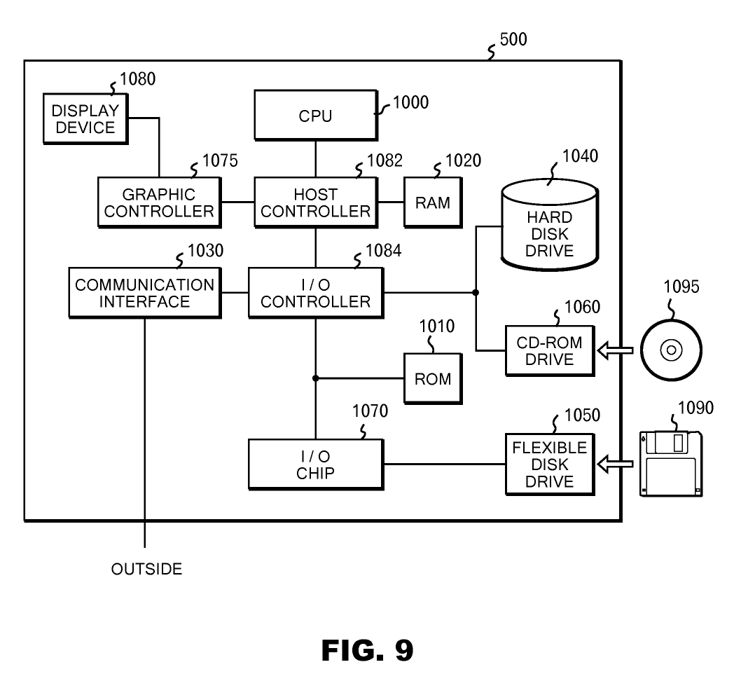

FIG. 9 is a hardware configuration of the information processing apparatus 500 functioning as the detection system 30. The information processing apparatus 500 includes a CPU peripheral unit, an input/output unit and a legacy input/output unit. The CPU peripheral unit includes the CPU 1000, the RAM 1020 and a graphics controller 1075, all of which are mutually connected to one another via a host controller 1082. The input/output unit includes a communication interface 1030, a hard disk drive 1040 and a CD-ROM drive 1060, all of which are connected to the host controller 1082 via an input/output controller 1084. The legacy input/output unit includes a ROM 1010, a flexible disk drive 1050 and an input/output chip 1070, all of which are connected to the input/output controller 1084.

The host controller 1082 connects the RAM 1020 to the CPU 1000 and the graphics controller 1075, both of which access the RAM 1020 at a high transfer rate. The CPU 1000 is operated in accordance with programs stored in the ROM 1010 and in the RAM 1020, and controls each of the components. The graphics controller 1075 obtains image data that the CPU 1000 or the like generates in a frame buffer provided in the RAM 1020, and causes the obtained image data to be displayed on a display device 1080. Instead of this, the graphics controller 1075 may internally include a frame buffer in which the image data generated by the CPU 1000 or the like is stored.

The input/output controller 1084 connects the host controller 1082 to the communication interface 1030, the hard disk drive 1040 and the CD-ROM drive 1060, all of which are relatively high-speed input/output devices. The communication interface 1030 communicates with an external device via a network. In the hard disk drive 1040, programs and data used by the information processing apparatus 500 are stored. The CD-ROM drive 1060 reads a program or data from a CD-ROM 1095, and provides the RAM 1020 or the hard disk 1040 with the read-out program or data.

Moreover, the input/output controller 1084 is connected to relatively low-speed input/output devices such as the ROM 1010, the flexible disk drive 1050 and the input/output chip 1070. In the ROM 1010, stored are programs such as a boot program executed by the CPU 1000 at a start-up time of the information processing apparatus 500 and a program depending on hardware of the information processing apparatus 500. The flexible disk drive 1050 reads a program or data from a flexible disk 1090, and provides the RAM 1020 or the hard disk drive 1040 with the read-out program or data, via the input/output chip 1070. The input/output chip 1070 is connected to the flexible disk drive 1050 and various kinds of input/output devices, for example, through a parallel port, a serial port, a keyboard port, a mouse port and the like.

A program to be provided to the information processing apparatus 500 is provided by a user with the program stored in a storage medium such as the flexible disk 1090, the CD-ROM 1095 and an IC card. The program is read from the storage medium via the input/output chip 1070 and/or the input/output controller 1084, and is installed and executed on the information processing apparatus 500. An operation that the program causes the information processing apparatus 500 or the like to execute, is identical to the operation of the detection system 30 described by referring to FIGS. 1 to 8. Accordingly, the description thereof is omitted here.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It should be understood, of course, that the foregoing relates to exemplary embodiments of the invention and that modifications may be made without departing from the spirit and scope of the invention as set forth in the following claims.

We claim:

1. A system for detecting an anomaly in an observation target on the basis of time series data of observed values obtained by observing the observation target, comprising:
a first generation unit for generating a first matrix by arranging, as a column vector, each of a plurality of time series data subsequences, out of the time series data, respectively observed in a plurality of reference periods for anomaly detection;
a second generation unit for generating a second matrix by arranging, as a column vector, each of a plurality of time series data subsequences, out of the time series data, respectively observed in a plurality of target periods for anomaly detection;
a singular vector computation unit for computing a singular vector of the second matrix;
a matrix product computation unit for computing a product matrix by multiplying the first matrix by the transposed matrix of the first matrix from the right;
an element computation unit for computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix;
an eigenvector computation unit for computing eigenvectors of the tridiagonal matrix; and
a change degree computation unit for computing the degree of change in the observation target from the reference periods to the target periods for anomaly detection, on the basis of a linear combination of the inner products between each of the eigenvectors and the singular vector, and for outputting the computed degree as a score indicating an anomaly in the observation target.

2. The system according to claim 1, wherein the element computation unit computes the diagonal elements and subdiagonal elements of the tridiagonal matrix that is tridiagonalized by using orthonormal bases of a Krylov subspace having the number of dimensions smaller than the number of lines of the product matrix, and that has the number of lines smaller than that of the product matrix.

3. The system according to claim 2, wherein
the product matrix is tridiagonalized by multiplying the product matrix by a square matrix from the right, and by the transposed matrix of the square matrix from the left, the square matrix including each of orthonormal bases of the product matrix arranged as a column vector, and
the element computation unit computes the diagonal elements and subdiagonal elements of a tridiagonal matrix that is approximately tridiagonalized by multiplying the product matrix by a non-square matrix from the right in place of the square matrix, and by the transposed matrix of the non-square matrix from the left in place of the transposed matrix of the square matrix, the non-square matrix including each of orthonormal bases of the Krylov subspace arranged as a column vector.

4. The system according to claim 1, wherein
the second generation unit generates a next second matrix for each of a plurality of periods starting at a time point later than one of the periods that have been used for generating the preceding second matrices, every time a new observed value is obtained from the observation target, and
the singular vector computation unit computes a singular vector of the next second matrix by using an orthogonal iteration method using, as an initial value of a solution, a vector based on a singular vector computed for the pervious second matrix.

5. The system according to claim 4, wherein the singular vector computation unit computes the singular vectors of the next second matrix by using an orthogonal iteration method using, as an initial value of a solution, a vector obtained in such a way that another vector having a direction different from, and being shorter than the singular vector of the previous second matrix is added to the singular vector of the previous second matrix.

6. A method for detecting an anomaly in an observation target on the basis of time series data of observed values obtained by observing the observation target, comprising the steps of:
generating a first matrix by arranging, as a column vector, each of a plurality of time series data subsequences, out of the time series data, respectively observed in a plurality of reference periods for anomaly detection;
generating a second matrix by arranging a plurality of time series data subsequences, out of the time series data, respectively observed in a plurality of target periods for anomaly detection;
computing a singular vector of the second matrix,
computing a product matrix by multiplying the first matrix by the transposed matrix of the first matrix from the right;
computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix,
computing eigenvectors of the tridiagonal matrix,
computing the degree of change in the observation target from the reference periods to the target periods for anomaly detection, on the basis of a linear combination of the inner products between each of the eigenvectors and the singular vector, and
outputting the computed degree as a score indicating an anomaly in the observation target.

7. The system according to claim 6, wherein,
every time a new observed value is obtained from the observation target, the first generation unit generates the first matrix by using, as the plurality of reference periods for anomaly detection, a plurality of periods that have the same time length, and that respectively start at a plurality of time points obtained by accumulatively and sequentially adding a predetermined difference period to a first reference time point preceding the observation time point of the new observed value, for a predetermined period,
every time a new observed value is obtained from the observation target, the second generation unit generates the second matrix by using, as the plurality of target periods for anomaly detection, a plurality of periods that have the same time length, and that respectively start at a plurality of time points obtained by accumulatively and sequentially adding the predetermined difference period to a second reference time point after the first reference time point, and
every time a new observed value is obtained from the observation target, the change degree computation unit computes the score, and outputs the score as a score indicating an anomaly in the observation target around the observation time point of the new observed value.

8. A computer program product comprising a computer useable medium including a computer readable program, wherein the computer readable program when executed on a computer causes the computer to function as a system for detecting an anomaly in an observation target on the basis of time series data of observed values obtained by observing the observation target, the computer program product causing the computer to function as:
a first generation unit for generating a first matrix by arranging, as a column vector, each of a plurality of time series data subsequences, out of the time series data, respectively observed in a plurality of reference periods for anomaly detection;
a second generation unit for generating a second matrix by arranging, as a column vector, each of a plurality of time series data subsequences, out of the time series data, respectively observed in a plurality of target periods for anomaly detection;
a singular vector computation unit for computing a singular vector of the second matrix;
a matrix product computation unit for computing a product matrix by multiplying the first matrix by the transposed matrix of the first matrix from the right;
an element computation unit for computing the diagonal elements and subdiagonal elements of a tridiagonal matrix of the product matrix that is tridiagonalized by using a matrix in which each of orthonormal bases of a Krylov subspace of the product matrix including the singular vector as a base is arranged as a column vector, and the transposed matrix of the matrix;
an eigenvector computation unit for computing eigenvectors of the tridiagonal matrix; and
a change degree computation unit for computing the degree of change in the observation target from the reference periods to the target periods for anomaly detection, on the basis of a linear combination of the inner products between each of the eigenvectors and the singular vector, and for outputting the computed degree as a score indicating an anomaly in the observation target.

9. The program according to claim 8, wherein
the first generation unit generates the first matrix by using, as time series data, observed values of the tension of steel strips sequentially manufactured with steelmaking equipment,
the second generation unit generates the second matrix by using, as time series data, observed values of the tension of steel strips sequentially manufactured with the steelmaking equipment, and
the change degree computation unit computes a score indicating a change in the tension of steel strips, and outputs the score as a score indicating an anomaly in the steelmaking equipment.
